(19) United States
(12) Patent Application Publication
(10) Pub. No.: US 2015/0275425 A1
(43) Pub. Date: Oct. 1, 2015

(54) Sublimation Transfer Dyeing Method And Developer

(71) Applicants: NIPPON KAYAKU KABUSHIKI KAISHA, Tokyo (JP); ETOWAS CO., LTD., Osaka (JP)

(72) Inventors: Makoto Teranishi, Tokyo (JP); Yuji Suzuki, Tokyo (JP); Hirokazu Kitayama, Tokyo (JP); Yoshihiro Takai, Osaka (JP); Kousuke Takai, Osaka (JP)

(21) Appl. No.: 14/437,289

(22) PCT Filed: Nov. 6, 2013
(86) PCT No.: PCT/JP2013/079970

§ 371 Date: Apr. 21, 2015

(30) Foreign Application Priority Data
Nov. 8, 2012 (JP) 2012-246310

(51) Int. Cl. D06P 5/28; G03G 9/087; G03G 9/097

(52) U.S. Cl. CPC D06P 5/006; G03G 9/09708; G03G 9/08755

(57) ABSTRACT

[Object] To provide: a sublimation transfer printing method of a dry developing system, particularly a dry nonmagnetic developing system, still particularly a dry nonmagnetic one-component developing system, said sublimation transfer printing method being capable of achieving a high color depth and suppressing the staining of non-image areas of a printed product and the unevenness of printing thereof; a printed product obtained by the printing method; an intermediate recording medium which is to be used in the printing method; and a toner.

[Means of Achievement] A sublimation transfer printing method which comprises adhering a toner to an intermediate recording medium according to an electrophotographic process, and transferring the dye contained in the toner adhered to the intermediate recording medium to an object to be printed through the sublimation of the dye, wherein: the toner comprises, as essential components, a polyester resin, a sublimable dye, and an external additive which contains strontium titanate as an essential component; and the amount of the strontium titanate is more than 0.3 to less than 3.0 mass % relative to the total mass of the toner. According to the sublimation transfer printing method, a high-quality printed product which exhibits a high color depth and is in an evenly printed state and the non-image areas of which are not stained can be obtained.

### TECHNICAL FIELD

The present invention relates to a sublimation transfer dyeing method for dyeing an object to be dyed using an intermediate recording medium to which a toner for sublimation transfer has been imparted, to a dyed product obtained by the dying method, to a toner used in the dyeing method, and to a method for suppressing unevenness of dyeing using the sublimation transfer dyeing method.

### BACKGROUND ART

Dyeing methods using an electrophotographic process for hydrophobic fibers such as polyester cloth or hydrophobic resins such as PET films can be broadly classified into two categories.

Specifically, these two categories include direct methods in which a toner is directly imparted to an object to be dyed, after which a dye contained in the toner is ingrained by heat treatment into the object to be dyed; and sublimation transfer methods in which a toner is imparted to paper or another intermediate recording medium, after which the toner-imparted surface of the intermediate recording medium and the object to be dyed are superposed on each other and then heat-treated, and the dye contained in the toner is sublimation-transferred to the object to be dyed.

Of these two categories of methods, sublimation transfer methods are considered to be suitable for dyeing applications in which texture is important, such as for sports apparel and other clothing items. Disperse dyes suitable for dyeing hydrophobic fibers, or, among oil-soluble dyes, particularly easy-sublimating dyes having excellent suitability for sublimation transfer to hydrophobic fibers by heat treatment, and the like are used as dyes in toners used in sublimation transfer methods.

When a sublimation transfer method is used in an electrophotographic process, it is possible to cause only the dye component of the plurality of components constituting the toner to be ingrained in the fibers from the intermediate recording medium. As a result, toner components other than the dye do not adhere to the dyed cloth, and some advantages are obtained, for example, which are as follows: the method is suitable for applications in which the texture of the material is considered important, such as for clothing items, sheets, sofas, and other interior items, or bedding, for example, and it is possible to reduce the risk of toner components causing rash, eczema, and the like in people having sensitive skin.

Having no need for washing/drying and other steps also brings some advantages, which are as follows: the dyeing steps are significantly reduced, and for the need of a high-cost washing/drying line, wash water treatment facility, or the like which requires a large amount of space and large amounts of energy to operate are eliminated.

Consequently, a sublimation transfer method is considered as an excellent dyeing method capable of dyeing in a small space.

An inkjet process is commonly used as a means for dyeing fibers by a sublimation transfer method.

However, sublimation transfer dyeing by an inkjet process has drawbacks in that the organic solvent which is one component of the ink is volatilized by heat during dye transfer, and contaminates the work environment.

In an electrophotographic process, however, volatile components are not present in the toner thereof and therefore do not contaminate the work environment, the advent of a photosensitive drum capable of an output width of 900 mm and the resultant size of dyeable fibers (or cloth structured from the fibers) enables application to the field of sports apparel, the dyed surface area per unit time is greater than in an inkjet process (serial printing process), and other advantages are obtained. Electrophotographic processes have therefore garnered attention in recent years.

Developers used in dry electrophotographic processes include one-component developers comprised of a toner solely and two-component developers comprised of a toner and a carrier. Dry-toner development processes using these developers are further classified according to differences in basic development functions, which are (1) replenishment of toner, (2) charging of toner, (3) formation of a thin-layer coating of the developer on a development roller, (4) development, and (5) elimination of development history.

These processes are generally classified into two types including magnetic one-component development processes and nonmagnetic one-component development processes according to what is used to impart a charge to the toner and to convey the toner when an electrically insulating toner is used.

In a magnetic one-component development process, a magnetic toner containing a magnetic body is used alone as the developer. Magnetic force acting on the toner is used directly for toner conveyance, and rubbing against the development roller is primarily used for imparting an electric charge to the toner by friction.

Meanwhile, in a nonmagnetic one-component development process, a nonmagnetic toner is used alone as the developer. In this configuration, rubbing against the development roller is primarily used for imparting an electric charge to the toner by friction, the toner is conveyed using mechanical conveyance and the electrostatic force created by frictional electric charging due to rubbing against the development roller. Nonmagnetic one-component development processes include contact-type processes in which development is performed while maintaining a toner layer in contact with a photosensitive body and non-contact-type processes in which development is performed while maintaining a non-contact state between a photosensitive body and a development roller for retaining a toner layer.

Of the aforementioned processes, in an image formation method using a dry nonmagnetic one-component development process in particular, it is known that there is usually variation in the amount of electric charge of the toner. Therefore, toner having a small amount of electric charge or toner charged in the opposite polarity to the original charge polarity of the toner adheres to the non-image area portion on the intermediate recording medium (i.e., on the intermediate recording medium, the “background” portion thereof where an image formation is not intended and no toner is expected to adhere), and staining of the non-image area portion (hereinafter referred to as “staining of the non-image area”) is extremely prone to occur.

Essentially, staining of the non-image area on the intermediate recording medium is not significantly prominent insofar as the staining is not severe enough to be clearly confirmed visually. However, when the intermediate recording medium which does not appear to have prominent staining of the non-image area is used in sublimation transfer dyeing, and an object to be dyed is subjected to sublimation transfer, staining of the non-image area of the dyed product (meaning the object obtained by dyeing an object to be dyed by sublimation transfer) becomes extremely prominent, which is a significant problem in sublimation transfer dyeing.

There is therefore a strong need to address the problem of suppressing staining of the non-image area of the dyed product in a sublimation transfer dyeing method.

However, it is generally difficult to suppress staining of the non-image area and achieve high dyeing density at the same time in a sublimation transfer dyeing method, and it is recognized that there is a tradeoff between these objects. Consequently, a sublimation transfer dyeing method whereby high dyeing density is achieved and staining of non-image areas can be adequately suppressed has not yet been discovered.

Sublimable dyes used for sublimation transfer have poor dispersion stability in comparison with common pigments or dyes used in color toners for electrophotographic applications, and therefore have drawbacks in that the sublimable dyes bleed out on the particle surfaces of the toner due to changes over time and adversely affect the fluidity or cohesiveness of the toner, and cause uneven density, uneven sweeping, image memory (ghosting), and other image defects in the intermediate recording medium.

Sublimation transfer dyeing using an electrophotographic process is disclosed in Patent References 1 through 5 below, for example.

### PRIOR ART REFERENCES

### Patent References

Patent Reference 1: Japanese Laid-open Patent Application No. 02-295787

Patent Reference 2: Japanese Laid-open Patent Application No. 06-051591

Patent Reference 3: Japanese Laid-open Patent Application No. 10-058638

Patent Reference 4: Japanese Laid-open Patent Application No. 2000-029238

Patent Reference 5: Japanese National Publication No. 2006-500602

### SUMMARY OF THE INVENTION

### Problems to be Solved by the Invention

The object of the present invention is to provide: a sublimation transfer dyeing method for a dry development process, especially a dry nonmagnetic development process, and particularly a dry nonmagnetic one-component development process, the sublimation transfer dyeing method being capable of achieving high dyeing density and suppressing staining of a non-image area and unevenness of dyeing; an dyed product dyed by the dyeing method; an intermediate recording medium used in the dyeing method; and a toner.

### Means Used to Solve the Above-Mentioned Problems

As a result of earnest investigation aimed at overcoming the aforementioned problems, the inventors achieved the present invention based on the findings that the problems can be overcome by a sublimation transfer dyeing method which uses a specific toner. The present invention specifically relates to items [1] through [11] below.

[1]

A sublimation transfer dyeing method, comprising:

attaching a toner to an intermediate recording medium by an electrophotographic process, and

sublimation-transferring a dye contained in the toner attached to the intermediate recording medium to an object to be dyed,

wherein the toner contains at least a polyester resin, a sublimable dye, and an external additive,

wherein the external additive contains at least strontium titanate.

[2]

The sublimation transfer dyeing method according to [1], wherein the electrophotographic process is a dry development process.

[3]

The sublimation transfer dyeing method according to [1] or [2], wherein the object to be dyed is selected from the group consisting of a hydrophobic fiber or a structure thereof, a film or sheet comprised of a hydrophobic resin, and a fabric, glass, metal, and ceramics coated with a hydrophobic resin.

[4]

A dyed product dyed by the sublimation transfer dyeing method according to any of [1] to [3].

[5]

A toner used in the sublimation transfer dyeing method according to any of [1] to [3], comprising at least a polyester resin, a sublimable dye, and an external additive, wherein the external additive contains at least strontium titanate.

[6]

An intermediate recording medium used in the sublimation transfer dyeing method according to any of [1] to [3],

wherein the toner is attached to the intermediate recording medium,

wherein the toner contains at least a polyester resin, a sublimable dye, and an external additive,

wherein the external additive contains at least strontium titanate.

[7]

A method for suppressing staining of a non-image area and unevenness of dyeing in a dyed product, using the sublimation transfer dyeing method according to any of [1] to [3].

[8]

A dyed product dyed by the sublimation transfer dyeing method according to any of [1] to [3], in which staining of a non-image area and unevenness of dyeing are suppressed.

[9]

A method for suppressing staining of a non-image area and unevenness of dyeing in a dyed product, using the toner according to [5].

[10]

A method for suppressing staining of a non-image area and unevenness of dyeing in a dyed product, using the intermediate recording medium according to [6].

[11]

An intermediate recording medium to which the toner according to [5] is attached.

### Advantages of the Invention

According to the present invention, the following are provided: a sublimation transfer dyeing method by a dry development process, especially a dry nonmagnetic development process, and particularly a dry nonmagnetic one-component development process, the sublimation transfer dyeing method being capable of achieving high dyeing density and suppressing staining of the non-image area and unevenness of dyeing; a dyed product dyed by the dyeing method; an intermediate recording medium used in the dyeing method; and a toner.

### BEST MODE FOR CARRYING OUT THE INVENTION

The toner used in the sublimation transfer dyeing method of the present invention contains at least a polyester resin, a sublimable dye, and an external additive, and the external additive contains at least strontium titanate.

The polyester resin is not particularly limited to, but includes a resin obtained by polycondensation of a polyhydric alcohol and a polyfunctional carboxylic acid, for example.

The polyhydric alcohol component is not particularly limited to, but includes dihydric alcohols such as ethylene glycol, propylene glycol, 1,3-propanediol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, 1,4-cyclohexane dimethanol, dipropylene glycol, polyethylene glycol, polypropylene glycol, bisphenol A, hydrogenated bisphenol A, ethylene oxide adducts of bisphenol A, and propylene oxide adducts of bisphenol A. Examples of trihydric or higher alcohols include glycerin, sorbitol, 1,4-sorbitan, 2-methylpropanetriol, trimethylolethane, trimethylolpropane, and the like. Among these, bisphenol A, hydrogenated bisphenol A, ethylene oxide adducts of bisphenol A, propylene oxide adducts of bisphenol A, and glycerin are preferred. These polyhydric alcohol components may be used singly or as a mixture of two or more types thereof.

The polyfunctional carboxylic acid is not particularly limited to, but includes aliphatic dicarboxylic acids and aromatic dicarboxylic acids. Aliphatic dicarboxylic acids include, for example, oxalic acid, malonic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, 1,18-octadecanedicarboxylic acid, maleic acid, fumaric acid, citraconic acid, itaconic acid, and the like. Aromatic dicarboxylic acids include, for example, phthalic acid, isophthalic acid, terephthalic acid, naphthalene-2,6-dicarboxylic acid, mesaconic acid, and the like. Dibasic acid salts or anhydrides of these dicarboxylic acids and derivatives such as C₁₋₆ lower alkyl esters may also be used. Among these, adipic acid, isophthalic acid, terephthalic acid, and the like are preferred. These polyfunctional carboxylic acids may be used singly or as a mixture of two or more types thereof.

The raw material for the polyester resin may, as needed, be octanoic acid, decanoic acid, dodecanoic acid, myristic acid, palmitic acid, stearic acid or another aliphatic monocarboxylic acid; an aliphatic monocarboxylic acid having branched or unsaturated groups; octanol, decanol, dodecanol, myristyl alcohol, palmityl alcohol, stearyl alcohol or another aliphatic monoalcohol; or benzoic acid, a naphthalene carboxylic acid, or another aromatic monocarboxylic acid.

A resin having strong high-temperature offset properties can also be synthesized using trimellitic acid or an anhydride thereof, pyromellitic acid, or another polyfunctional carboxylic acid, as appropriate, by crosslinking main chains thereof and forming a gel.

The content of each constituent unit corresponding to each of the aforementioned monomer in the total mass of the polyester resin is not particularly limited.

The number-average molecular weight (Mn) in terms of polystyrene of the THF (tetrahydrofuran) soluble part (hereinafter referred to as “THF soluble part”) of the polyester resin as measured by GPC analysis is not particularly limited, but is usually 1,000 to 20,000, preferably 2,000 to 10,000, and more preferably 3,000 to 5,000.

The mass-average molecular weight (Mw) in terms of polystyrene of the THF soluble part of the polyester resin as measured by GPC is not particularly limited, but is usually 10,000 to 300,000, preferably 20,000 to 280,000, and more preferably 50,000 to 270,000.

GPC analysis of the THF soluble part was performed using a 1.0% THF solution of the polyester resin as the sample solution in a high-speed GPC device (HLC-8320GPC EcoSEC, manufactured by Tosoh Corporation). The column used for analysis was configured from one TSKgel/SuperHZ1000 column (manufactured by Tosoh Corporation), one TSKgel/SuperHZ2000 column (manufactured by Tosoh Corporation), and two TSKgel/SuperMultiporeHZ-H columns (manufactured by Tosoh Corporation).

The acid value of the polyester resin is not particularly limited, but is usually 1 to 30 mg KOH/g, preferably 2 to 40 mg KOH/g, and more preferably 4 to 30 mg KOH/g.

The polyester resin may be manufactured, or a commercially available polyester resin may be obtained.

When the polyester resin is manufactured, the method of manufacturing thereof is not particularly limited, and any method that is publicly known may be used. For example, a bulk polymerization method, a solution polymerization method, or other methods may be used. Resins manufactured by a plurality of these polymerization methods may also be mixed together.

The aforementioned polyester resins include polyester resins obtainable as commercial products. Examples thereof include the Mitsubishi Rayon Co., Ltd. products DIACRON® FC-611, DIACRON® FC-684, DIACRON® FC-1224, DIACRON® FC-1233, DIACRON® FC-1565, DIACRON® FC-2232, and the like. Among these products, DIACRON® FC-1224, DIACRON® FC-1233, and DIACRON® FC-2232 are preferred.

The sublimable dye is not particularly limited, but a dye suitable for sublimation transfer is preferred.

“A dye suitable for sublimation transfer” means a dye for which the staining (polyester) test result in a dry heat treatment test (C method) in the “Test Methods for Color Fastness to Dry Heat [JIS L 0879:2005] (confirmed 2010, revised Jan. 20, 2005, published by Japanese Standards Association)” is usually level 3-4 or lower, and preferably level 3 or lower. Among such dyes, the dyes listed below are cited as examples of publicly known dyes.

Yellow dyes include C.I. Disperse Yellow 3, 7, 8, 23, 39, 51, 54, 60, 71, and 86; C.I. Solvent Yellow 114 and 163; and the like.

Orange dyes include C.I. Disperse Orange 1, 1:1, 5, 20, 25, 25:1, 33, 56, and 76; and the like.

Brown dyes include C.I. Disperse Brown 2 and the like.

Red dyes include C.I. Disperse Red 11, 50, 53, 55, 55:1, 59, 60, 65, 70, 75, 93, 146, 158, 190, 190:1, 207, 239, and 240; C.I. Vat Red 41; and the like.

Violet dyes include C.I. Disperse Violet 8, 17, 23, 27, 28, 29, 36, and 57; and the like.

Blue dyes include C.I. Disperse Blue 19, 26, 26:1, 35, 55, 56, 58, 64, 64:1, 72, 72:1, 81, 81:1, 91, 95, 108, 131, 141, 145, 359, and 360; C.I. Solvent Blue 3, 63, 83, 105, and 111; and the like.

The abovementioned dyes may each be used singly, or two or more dyes may be used in combination.

A plurality of dyes are preferably blended to obtain a hue such as black, for example, which is completely different from the original dye. At this time, black dye can be obtained by appropriately blending blue dye as a main component with yellow dye and red dye, for example.

A plurality of dyes may also be blended for such purposes as finely adjusting a blue, yellow, orange, red, violet, black, or other color tone to a more preferred color tone, or obtaining an intermediate color.

The external additive generally increases fluidity of toner particles and improves charging characteristics during development. Numerous types of external additives are known, such as described below, but the external additive must contain at least strontium titanate in order to suppress staining of the non-image area. When the external additive does not contain strontium titanate, the toner charge gradually decreases when durability testing is performed, and in conjunction with this effect, fogging of an intermediate recording medium increases, and staining of the non-image area that occurs when this fogging is sublimation-transferred to the recording medium becomes prominent. It has been discovered that adding strontium titanate as an external additive has the effect of stabilizing the amount of charge in durability testing. The mechanism responsible for this effect is merely speculative, but because the particle diameter of the strontium titanate is about one tenth the particle diameter of the toner, rather than always adhering to the toner as in the case of silica, the strontium titanate may stabilize charge while adhering to and separating from the toner in the manner of a carrier in a two-component developer, for example.

The primary particle diameter of the external additive is usually 5 nm to 2 μm, preferably 5 nm to 500 nm, and more preferably 5 nm to 200 nm. The specific surface area of the external additive as measured by a BET method is preferably 20 to 500 m²/g.

Strontium titanate can be obtained as a commercial product. Specific examples thereof include ST, CT, HST-1, HPST-1, and HPST-2 manufactured by Fuji Titanium Industry Co., Ltd.; and SW-100, SW-50C, SW-100C, SW-200C, SW-320C, and the like manufactured by Titan Kogyo, Ltd. Among these, SW-100 is preferred.

The external additive may be used alone insofar as the external additive contains strontium titanate, and strontium titanate and another external additive may be used in combination.

Specific examples of external additives that can be used in combination with strontium titanate include silica, alumina, titanium dioxide, barium titanate, magnesium titanate, calcium titanate, zinc oxide, tin oxide, silica sand, clay, mica, wollastonite, diatomaceous earth, chromium oxide, cerium oxide, red oxide, antimony trioxide, magnesium oxide, zirconium oxide, barium sulfate, barium carbonate, calcium carbonate, silicon carbide, silicon nitride, and the like. Among these, silica is preferred.

The aforementioned external additives include external additives obtainable as commercial products. Examples of silica products include AEROSIL® R812, AEROSIL® RX50, AEROSIL® RX200, and AEROSIL® RX300 manufactured by Nippon Aerosil Co., Ltd., TG-6110G, TG-810G, and TG-811F manufactured by Cabot Japan K.K., H2000/4, H2000T, H05™, H13™, H20™, and H30™ manufactured by Clariant (Japan) K.K., and the like; examples of alumina products include AEROXIDE® AluC 805 manufactured by Nippon Aerosil Co., Ltd., and the like; examples of titanium dioxide products include STT-30A and EC-300 manufactured by Titan Kogyo, Ltd., AEROXIDE® TiO₂ T805 and AEROXIDE® TiO₂ NKT90 manufactured by Nippon Aerosil Co., Ltd., and the like. Among these products, silica is preferred, and AEROSIL® R812, AEROSIL® RX50, and the like are specifically preferred.

The content of polyester resin in the toner is not particularly limited, and an appropriate content can be selected according to purpose. As a guideline, the resin content with respect to the total mass of the toner is usually 59.5 to 96%, preferably 64.3 to 96%, and more preferably 69.2 to 88.2%.

When strontium titanate and another external additive are used in combination as external additives, as a guideline, the resin content with respect to the total mass of the toner is usually 59.5 to 94%, and preferably 64.3 to 93.1%.

When the resin content is too low, the dye disperses poorly in the toner, which leads to reduced electrical characteristics in the toner. A reduction in dyeing density is observed when the resin content is too high.

The content of sublimable dye contained in the toner is not particularly limited, and an appropriate content can be selected according to purpose. As a guideline, the sublimable dye content with respect to the total mass of the toner is usually 1 to 40%, and preferably 2 to 35%.

A reduction in dyeing density is observed when the sublimable dye content is too low, and when the sublimable dye content is too high, the sublimable dye disperses poorly in the toner, which leads to reduced electrical characteristics in the toner.

As a guideline, the strontium titanate content in the toner with respect to the total mass of the toner is usually greater than 0.3% and less than 3.0%, preferably 0.4% to 3.0%, more preferably 0.4% to 2.5%, and more preferably 0.5% to 2.0%.

The value of the content is rounded to the nearest tenth and indicated to one decimal place.

When strontium titanate and another external additive are used in combination as external additives contained in the toner, the total content of the external additives is not particularly limited, and an appropriate content can be selected. As a guideline, the total content of external additives with respect to the total mass of the toner is usually 0.5 to 5.0%, and preferably 0.7 to 4.9%.

The volume-average particle diameter (D50 Vol.) of the toner is not particularly limited, but is usually 4 μm to 12 μm, preferably 5 μm to 10 μm, and more preferably 6 μm to 10 μm.

The average particle diameter is measured using a precision particle size distribution measuring device (Multisizer® 4, manufactured by Beckman Coulter, Inc.), and unless otherwise specified, measured values thereof are rounded to the nearest tenth and indicated to one decimal place.

The toner may further contain a wax, a charge control agent, or the like as needed.

The wax is not particularly limited, and an appropriate wax can be selected from among publicly known waxes. Among such waxes, a low-melting wax having a melting point of 50 to 120° C. is preferred. By dispersing the polyester resin, a low-melting wax works effectively as a release agent between a fixing roller and a toner interface, and good hot offset resistance is thereby obtained even in an oil-less configuration (a method in which a release agent such as oil, for example, is not applied to the fixing roller).

Examples of the wax include carnauba wax, cotton wax, Japan wax, rice wax, and other plant-based waxes; beeswax, lanolin, and other animal-based waxes; montan wax, ozokerite, selsyn, and other mineral-based waxes; paraffin, microcrystallin, petrolatum, and other petroleum waxes; and other natural waxes.

Examples also include synthetic wax such as Fischer-Tropsch wax, polyethylene wax, and other synthetic hydrocarbon waxes; esters, ketones, ethers, and other synthetic waxes.

Furthermore, amides of 12-hydroxystearic acid, amides of stearic acid, imides of anhydrous phthalic acid, and aliphatic amides of chlorinated hydrocarbons and the like; homopolymers or copolymers of poly-n-stearylmethacrylate, poly-n-laurylmethacrylate, and other polyacrylates, which are crystalline polymer resin having low molecular weight, (e.g., n-stearylacrylate-ethylmethacrylate copolymer and the like); and crystalline polymers having long alkyl groups in a side chain thereof and the like may be used as the wax.

Any of the aforementioned waxes may be used singly, or two or more types thereof may be used in combination.

The melt viscosity of the wax as measured at a temperature 20° C. higher than the melting point of the wax is preferably 5 to 1000 cps, and more preferably 10 to 100 cps.

Release properties may decline when the melt viscosity is less than 5 cps, and when the melt viscosity exceeds 1000 cps, enhanced hot offset resistance and/or low-temperature fixing properties may no longer be obtained.

The aforementioned waxes include waxes obtainable as commercial products. Examples of preferred carnauba wax products include Carnauba Wax C1 manufactured by S. Kato & Co., and the like; and examples of preferred montan wax products include Licowax KP manufactured by Clariant (Japan) K.K., and the like. Among these examples, Carnauba Wax C1 is preferred.

The content of the wax contained in the toner is not particularly limited, and an appropriate content can be selected according to purpose. As a guideline, the wax content with respect to the total mass of the resin contained in the toner is usually 0.5 to 20%, and preferably 1 to 10%. When the wax is contained in such an amount, “the content of polyester resin contained in the toner” may be interpreted as “the total content of polyester resin and wax contained in the toner.”

Offset on the fixing roller occurs when the wax content is too low, and when the wax content is too high, filming of free wax on the photoreceptor or staining of the development roller occurs.

The charge control agent is not particularly limited, and an appropriate charge control agent can be selected from among publicly known charge control agents.

Specific examples thereof include nigrosine-based dyes, triphenyl methane-based dyes, chromium-containing metal complex dyes, molybdenum oxide chelate pigments, rhodamine-based dyes, alkoxy-based amines, quaternary ammonium salts (including fluorine-modified quaternary ammonium salts), alkyl amides, elemental phosphorus or a compound thereof, elemental tungsten or a compound thereof, fluorine-based activators, metal salts of salicylic acid, metal salts of salicylic acid derivatives, and the like. Among these examples, metal salts of salicylic acid and metal salts of salicylic acid derivatives are preferred.

Any of the aforementioned charge control agents may be used singly, or two or more types thereof may be used in combination.

The aforementioned charge control agents include charge control agents obtainable as commercial products. Examples thereof include the nigrosine-based dye Bontron® 03, the quaternary ammonium salt Bontron® P-51, the metal-containing azo dye Bontron® S-34, the oxy-naphthoic acid-based metal complex Bontron® E-82, the salicylic acid-based metal complex Bontron® E-84, and the phenol-based condensation product Bontron® E-89 (each manufactured by Orient Chemical Industries Co., Ltd.); the quaternary ammonium salt molybdenum complexes TP-302 and TP-415 (each manufactured by Hodogaya Chemical Co., Ltd.); the quaternary ammonium salt Copy Charge® PSY VP2038, the triphenylmethane derivative Copy Blue PR, the quaternary ammonium salts Copy Charge® NEG VP2036 and Copy Charge® NX VP434 (each manufactured by Hoechst AG); LRA-901 and the boron complex LR-147 (manufactured by Japan Carlit Co., Ltd.); copper phthalocyanine; perylene; quinacridone; azo-based pigments; or polymer-based compounds having sulfonic acid groups, carboxyl groups, quaternary ammonium salts, and other functional groups; and the like.

The content of the charge control agent contained in the toner is not particularly limited, and an appropriate content can be selected according to purpose. The content differs according to the type of the resin, the presence or absence of additives, the method of dispersion, and other factors, and is difficult to specify unconditionally. However, as a guideline, the charge control agent content with respect to the total mass of the resin contained in the toner is usually 0.1 to 10%, and preferably 0.2 to 5%.

Charge control properties may not be obtained when the charge control agent content is less than 0.1%. When the charge control agent content exceeds 10%, the electrostatic propensity of the toner becomes too great, the effect of the charge control agent decreases, and electrostatic attraction to the development roller increases, leading to reduced fluidity of the toner or reduced image density.

The method for manufacturing the toner will be described.

The method for manufacturing the toner may be a pulverization method for fabricating the toner through processes of kneading, pulverization, and classification; a polymerization method (e.g., emulsion polymerization, solution suspension, emulsion aggregation, polyester extension, and the like) for polymerizing a polymerizable monomer and forming toner particles while simultaneously controlling the shape or size thereof; or another publicly known manufacturing method. A pulverization method is preferred in terms of the ability to manufacture toner at high speed, and a polymerization method is preferred in terms of achieving a small volume-average particle diameter.

Of the methods described above, a method for manufacturing toner by pulverization generally includes the four manufacturing steps 1 through 4 described below.

“Manufacturing Step 1”

A step for mixing a dye, a resin, and, as needed, a charge control agent, a wax, and other components in a Henschel mixer or other mixing machine and obtaining a dye-resin mixture.

“Manufacturing Step 2”

A step for melt-kneading the dye-resin mixture obtained in Manufacturing Step 1 in a sealed kneader, or in a single- or twin-screw extruder or the like, and cooling the mixture to obtain a resin composition.

“Manufacturing Step 3”

A step for coarsely pulverizing the resin composition obtained in Manufacturing Step 2 in a hammer mill or the like, then finely pulverizing the resin composition in a jet mill, classifying the resin composition as needed using a cyclone or various types of classifying machines to obtain the desired particle size distribution, and obtaining toner base particles.

“Manufacturing Step 4”

A step for adding an external additive to the toner base particles obtained in Manufacturing Step 3 and mixing in a Henschel mixer or the like to obtain a toner.

In an electrophotographic process using a toner, an image is generally formed on an intermediate recording medium by the operations (1) through (3) described below.

(1) An electrostatic latent image formed by exposure light on a photosensitive drum or other latent image carrier is developed by a developer using a toner, and a toner image is formed.

(2) The obtained toner image is transferred to paper or another intermediate recording medium by a transfer member, and a toner image is thereby formed on the intermediate recording medium.

(3) The obtained intermediate recording medium is heated and pressed by a fixing device, and the toner image formed on the intermediate recording medium is fixed on the intermediate recording medium. Formation of an image on the intermediate recording medium is thereby completed.

The fixing device is not particularly limited, but is usually one in which a paper sheet is held between a pair of rollers provided with a heater, and heating and pressing are performed while the paper sheet is conveyed by rotation of the rollers. The surface temperature of the rollers is usually raised to about 90 to 190° C. by the heater.

The fixing device may be provided with a cleaning function. The cleaning method may be a method in which silicone oil is supplied to the rollers to clean the rollers; a method in which the rollers are cleaned by a pad, roller, web, or the like impregnated with silicone oil; or another method.

As an example of a sublimation transfer dyeing method, a dyeing method is cited in which a toner is affixed by a publicly known electrophotographic process, for example, to the intermediate recording medium to form a toner image, after which the toner-affixed surface of the intermediate recording medium and an object to be dyed are superposed on each other, and heat treatment is then performed usually at about 190 to 210° C., whereby the sublimable dye in the toner is transfer-dyed from the intermediate recording medium to the object to be dyed, and the toner image on the intermediate recording medium is sublimation-transferred to the object to be dyed.

Examples of the object to be dyed include hydrophobic fibers (or cloth or the like constructed from the same) such as polyester; films, sheets, or the like comprised of hydrophobic resin, such as PET films or PET sheets; and fabric, glass, metal, ceramics, and the like coated with a hydrophobic resin.

The sublimation transfer dyeing method and toner using the same of the present invention have excellent development characteristics, and make it possible to obtain an intermediate recording medium having an excellent toner image having almost no fogging and being devoid of uneven density, uneven sweeping, image memory (ghosting), and other image defects, even in a contact or non-contact dry development process, particularly in image formation using a full-color large format printer. As a result, staining of the non-image area and unevenness of dyeing can be suppressed even while the sublimable dye contained in the toner on the intermediate recording medium is sublimation-transferred with high transfer efficiency to the object to be dyed, and it is therefore possible to provide a high-quality dyed product having high dyeing density and no staining of the non-image area or UNEVENNESS OF DYEING.

### EXAMPLES

The present invention will be described in further detail below using examples, but these examples do not limit the present invention. Unless otherwise specified, “parts” and “%” are based on mass in the examples. When the desired amount of a substance is not obtained by a single operation, the same operation is repeated until the desired amount of the substance is obtained.

In the examples, the volume-average particle diameter (D50 Vol.) is measured using a “Multisizer® 4” (manufactured by Beckman Coulter, Inc.) precision particle size distribution measuring device.

### Example 1

### Step 1

DIACRON® FC-2232 (96 parts), C.I. Disperse Blue 359 (14 parts), Bontron® E-84 (1 part), and Carnauba Wax C1 (3 parts) were premixed for 10 minutes in a Henschel mixer at a rotation speed of 30 m/second, and then melt-kneaded in a twin-screw extruder. The resultant melt-kneaded product was then pulverized/classified using a pulverizing/classifying machine, and a toner base having a volume-average particle diameter of 7.9 μm was thereby obtained.

### Step 2

The toner base (100 parts) obtained in Example 1 (Step 1), RX50 (1 part), R812 (1 part), and SW-100 (1 part) were then placed in a Henschel mixer, external addition was performed by stirring for 10 minutes at a rotation speed of 30 m/second, and a cyan toner 1 (C-1) of Example 1 was obtained.

### Example 2

A magenta toner 1 (M-1) of Example 2 having a volume-average particle diameter of 7.8 μm was obtained by the same procedures as in (Step 1) and (Step 2) of Example 1, except that C.I. Disperse Red 60 (10 parts) was used instead of the C.I. Disperse Blue 359 used in Example 1 (Step 1).

### Example 3

A yellow toner 1 (Y-1) of Example 3 having a volume-average particle diameter of 8.0 μm was obtained by the same procedures as in (Step 1) and (Step 2) of Example 1, except that C.I. Disperse Yellow 54 (5 parts) was used instead of the C.I. Disperse Blue 359 used in Example 1 (Step 1).

### Example 4

A black toner 1 (B-1) of Example 4 having a volume-average particle diameter of 7.9 μm was obtained by the same procedures as in (Step 1) and (Step 2) of Example 1, except that a mixture (20 parts) of C.I. Disperse Yellow 54, C.I. Disperse Blue 72, and C.I. Disperse Red 60 was used instead of the C.I. Disperse Blue 359 used in Example 1 (Step 1).

### Example 5

Four colors of toners including a cyan toner (C-2), a magenta toner (M-2), a yellow toner (Y-2), and a black toner (B-2) of Example 5 were each obtained by the same procedures as in Examples 1 through 4, except that SW-100 (0.5 part) was used instead of the SW-100 (1 part) used in each of Examples 1 through 4 (Step 2).

### Example 6

Four colors of toners including a cyan toner (C-3), a magenta toner (M-3), a yellow toner (Y-3), and a black toner (B-3) of Example 6 were each obtained by the same procedures as in Examples 1 through 4, except that SW-100 (2 parts) was used instead of the SW-100 (1 part) used in each of Examples 1 through 4 (Step 2).

### Comparative Example 1

Four colors of toners including a cyan toner (CC-1), a magenta toner (CM-1), a yellow toner (CY-1), and a black toner (CB-1) each for comparison were obtained by the same procedures as in the examples, except that STT-30A (1 part) was used instead of the SW-100 used in each of Examples 1 through 4 (Step 2).

### Comparative Example 2

Four colors of toners including a cyan toner (CC-2), a magenta toner (CM-2), a yellow toner (CY-2), and a black toner (CB-2) each for comparison were obtained by the same procedures as in the examples, except that a mixture of SW-100 (0.3 part) and STT-30A (0.7 part) was used instead of the SW-100 (1 part) used in each of Examples 1 through 4 (Step 2).

### Comparative Example 3

Four colors of toners including a cyan toner (CC-3), a magenta toner (CM-3), a yellow toner (CY-3), and a black toner (CB-3) each for comparison were obtained by the same procedures as in the examples, except that SW-100 (3.2 parts) was used instead of the SW-100 (1 part) used in each of Examples 1 through 4 (Step 2).

The evaluation tests described below were performed using toner sets of each of the four colors of toners obtained in Examples 1 through 4, Example 5, Example 6, and the comparative examples.

[A. Initial Evaluation Test]

Each toner set obtained in the examples and comparative examples was charged into a printer operating according to a dry nonmagnetic one-component development process (KIPc7800, manufactured by Katsuragawa Electric Co., Ltd.). Using A0-size bond paper as the intermediate recording medium, printing was performed under conditions of a coverage rate of 5%, a resolution of 600 pixel/inch, a fixing temperature of 135° C., and a developing bias of 200 V, and an intermediate recording medium (bond paper) was obtained on which solid images were printed in a total of seven colors including the four colors cyan, magenta, yellow, and black as single colors, and, for each of Examples 1 through 4 and the comparative examples, the three colors red, green and blue as composite colors. (In Table 2, red, green and blue are indicated as R-1, G-1, and B-1, respectively, in Examples 1 through 4. In Table 3, in Comparative Example 1, for example, red, green and blue are indicated as CR-1, CG-1, and CB-1, respectively.)

The toner-affixed surface of each resultant intermediate recording medium and a double pique (weight: 90 g/m²) configured from 100% polyester fibers as the object to be dyed were superposed on each other, then heat-treated at 195° C. for 60 seconds using a heating press machine (transfer press machine TP-600A2, manufactured by Horizon International Inc.), whereby double pique dyed products dyed by a sublimation transfer dyeing method were obtained.

As an initial evaluation test, the dyed portions of the resultant dyed products were subjected to colorimetry using a “SpectroEye (manufactured by GretagMacbeth GmbH)” spectrophotometer, and the initial dyeing density thereof immediately after the start of printing was measured. A dyeing density of 1.35 or greater was considered to be suitable for practical use. The measurement results are indicated in Table 2 below.

[B. Printing Durability Evaluation Test]

Solid images were printed on 1000 sheets of the intermediate recording medium at a coverage rate of 5% in the same manner as in “A. Initial Evaluation Test.” After the 1000 sheets were printed, printing on the intermediate recording medium was performed under the same conditions as in “A. Initial Evaluation Test,” and a four-color or seven-color intermediate recording medium was obtained for each toner set. Using each resultant intermediate recording medium and a double pique dyed product printed by the same sublimation transfer dyeing method as described above as test pieces, the state of printing and other properties after 1000 sheets of printing were evaluated according to the items described below: “C. Suitability of Printing,” “D. Average Charge of Toner,” “E. Dyeing density,” “F. Evaluation by Colorimetry Value of Non-image area Staining,” and “G. Evaluation of Unevenness of dyeing.” The results of each evaluation are indicated in Tables 2 and 3.

[C. Suitability of Printing]

The presence or absence of uneven sweeping and image memory were visually observed in a test piece of each resultant intermediate recording medium, and suitability of printing was evaluated according to the three levels described below.

A: Uneven sweeping and image memory are absent, and a uniform solid image is obtained.

B: Uneven sweeping and image memory are clearly observed.

C: Extremely prominent uneven sweeping and image memory are clearly observed.

[D. Average Charge of Toner]

The average charge of the toner after 1000 sheets of printing in each “B. Printing Durability Evaluation Test” was measured using an electric-field-flight-type electric charge measuring instrument.

[E. Dyeing Density]

Dyeing density was measured by colorimetry in the same manner as in “A. Initial Evaluation Test” using the double pique dyed products obtained in “B. Printing Durability Evaluation Test” as test pieces. The measurement results are indicated in Tables 2 and 3 below.

[F. Evaluation by Colorimetry Value of Non-Image Area Staining]

Using the double pique dyed products obtained in “B. Printing Durability Evaluation Test” as test pieces, the non-image area portions thereof were subjected to colorimetry using a “SpectroEye (manufactured by GretagMacbeth GmbH)” spectrophotometer, and the degree of staining of the non-image area was measured.

When a double pique was subjected to colorimetry in the same manner prior to dyeing, the measured value was 0.05. This numerical value therefore indicates a complete absence of staining of the non-image area.

[G. Visual Evaluation of Non-Image Area Staining]

Using the double pique dyed products used in “E. Evaluation by Colorimetry Value of Non-image area Staining” as test pieces, the degree of staining of the non-image area portion subjected to colorimetry was visually observed, and evaluated according to the three levels of standards described below.

A: Almost no staining of the non-image area is observed.

B: The presence of staining of the non-image area is clearly observed.

C: Severe staining of the non-image area is observed.

[H. Evaluation of Unevenness of Dyeing]

Using the double pique dyed products used in “E. Evaluation by Colorimetry Value of Non-image area Staining” as test pieces, the degree of unevenness of dyeing was visually observed, and evaluated according to the three levels of standards described below.

A: A high-quality dyed product devoid of unevenness of dyeing is obtained.

B: Unevenness of dyeing is clearly observed.

C: Severe unevenness of dyeing is observed.

The meanings of the codes in Table 1 are illustrated below.

SW-100: SW-100 manufactured by Titan Kogyo, Ltd

STT-30A: STT-30A manufactured by Titan Kogyo, Ltd.

RX50: RX50 manufactured by Nippon Aerosil Co., Ltd.

R812: R812 manufactured by Nippon Aerosil Co., Ltd.

TABLE 1

| Particle | | Volume- | | | | |
|---|---|---|---|---|---|---|
| diameter | | average | | | | |
| and | | particle | External additive | | | |
| external | Toner | diameter | SW-100 | STT-30A | RX-50 | R812 |
| additive | No. | (μm) | (parts) | (parts) | (parts) | (parts) |
| Example 1 | C-1 | 7.9 | 1.0 | 0.0 | 1.0 | 1.0 |
| Example 2 | M-1 | 7.8 | 1.0 | 0.0 | 1.0 | 1.0 |
| Example 3 | Y-1 | 8.0 | 1.0 | 0.0 | 1.0 | 1.0 |
| Example 4 | B-1 | 7.9 | 1.0 | 0.0 | 1.0 | 1.0 |
| Example 5 | C-2 | 7.9 | 0.5 | 0.0 | 1.0 | 1.0 |
| | M-2 | 7.8 | 0.5 | 0.0 | 1.0 | 1.0 |
| | Y-2 | 8.0 | 0.5 | 0.0 | 1.0 | 1.0 |
| | B-2 | 7.9 | 0.5 | 0.0 | 1.0 | 1.0 |
| Example 6 | C-3 | 7.9 | 2.0 | 0.0 | 1.0 | 1.0 |
| | M-3 | 7.8 | 2.0 | 0.0 | 1.0 | 1.0 |
| | Y-3 | 8.0 | 2.0 | 0.0 | 1.0 | 1.0 |
| | B-3 | 7.9 | 2.0 | 0.0 | 1.0 | 1.0 |
| Comparative | CC-1 | 7.9 | 0.0 | 1.0 | 1.0 | 1.0 |
| Example 1 | CM-1 | 7.8 | 0.0 | 1.0 | 1.0 | 1.0 |
| | CY-1 | 8.0 | 0.0 | 1.0 | 1.0 | 1.0 |
| | CB-1 | 7.9 | 0.0 | 1.0 | 1.0 | 1.0 |
| Comparative | CC-2 | 7.9 | 0.3 | 0.7 | 1.0 | 1.0 |
| Example 2 | CM-2 | 7.8 | 0.3 | 0.7 | 1.0 | 1.0 |
| | CY-2 | 8.0 | 0.3 | 0.7 | 1.0 | 1.0 |
| | CB-2 | 7.9 | 0.3 | 0.7 | 1.0 | 1.0 |
| Comparative | CC-3 | 7.9 | 3.2 | 0.0 | 1.0 | 1.0 |
| Example 3 | CM-3 | 7.8 | 3.2 | 0.0 | 1.0 | 1.0 |
| | CY-3 | 8.0 | 3.2 | 0.0 | 1.0 | 1.0 |
| | CB-3 | 7.9 | 3.2 | 0.0 | 1.0 | 1.0 |

TABLE 2

| | | | | After 1000 sheets printed | | | | | |
|---|---|---|---|---|---|---|---|---|---|
| | | Initial | | | | | Non-image area staining | | |
| Toner set and | | Dyeing | Charge | Suitability | Dyeing | Charge | Colorimetry | | Unevenness |
| print color | | density | (μC/g) | of printing | density | (μC/g) | value | Visual | of dyeing |
| Examples 1-4 | C-1 | 1.47 | 35.8 | A | 1.52 | 26.6 | 0.07 | A | A |
| | M-1 | 1.51 | 36.2 | A | 1.48 | 27.1 | 0.07 | A | A |
| | Y-1 | 1.49 | 37.1 | A | 1.50 | 26.4 | 0.06 | A | A |
| | K-1 | 1.38 | 35.8 | A | 1.41 | 26.1 | 0.07 | A | A |
| | R-1 | 1.39 | — | A | 1.41 | — | 0.07 | A | A |
| | G-1 | 1.43 | — | A | 1.43 | — | 0.07 | A | A |
| | B-1 | 1.48 | — | A | 1.49 | — | 0.08 | A | A |
| Example 5 | C-2 | 1.53 | 32.3 | A | 1.57 | 22.6 | 0.09 | A | A |
| | M-2 | 1.51 | 33.1 | A | 1.54 | 23.1 | 0.09 | A | A |
| | Y-2 | 1.47 | 34.1 | A | 1.51 | 24.1 | 0.08 | A | A |
| | K-2 | 1.49 | 32.7 | A | 1.54 | 24.4 | 0.09 | A | A |
| Example 6 | C-3 | 1.50 | 34.2 | A | 1.48 | 25.4 | 0.07 | A | A |
| | M-3 | 1.49 | 33.9 | A | 1.49 | 24.6 | 0.07 | A | A |
| | Y-3 | 1.51 | 34.5 | A | 1.52 | 25.9 | 0.07 | A | A |
| | K-3 | 1.52 | 33.8 | A | 1.47 | 26.1 | 0.08 | A | A |

TABLE 3

| | | | | After 1000 sheets printed | | | | | |
|---|---|---|---|---|---|---|---|---|---|
| | | Initial | | | | | Non-image area staining | | |
| Toner set and | | Dyeing | Charge | Suitability | Dyeing | Charge | Colorimetry | | Unevenness |
| print color | | density | (μC/g) | of printing | density | (μC/g) | value | Visual | of dyeing |
| Comparative | CC-1 | 1.46 | 32.8 | B | 1.41 | 21.7 | 0.12 | C | C |
| Example 1 | CM-1 | 1.43 | 33.1 | B | 1.36 | 22.5 | 0.12 | C | C |
| | CY-1 | 1.47 | 31.9 | B | 1.35 | 23.1 | 0.11 | C | B |
| | CK-1 | 1.48 | 32.7 | B | 1.37 | 22.5 | 0.12 | C | C |
| | CR-1 | 1.48 | — | B | 1.41 | — | 0.11 | C | C |
| | CG-1 | 1.43 | — | B | 1.35 | — | 0.12 | C | C |
| | CB-1 | 1.49 | — | B | 1.41 | — | 0.12 | C | C |
| Comparative | CC-2 | 1.46 | 30.6 | B | 1.39 | 20.6 | 0.11 | B | C |
| Example 2 | CM-2 | 1.44 | 31.1 | B | 1.43 | 21.9 | 0.11 | B | C |
| | CY-2 | 1.50 | 30.6 | B | 1.41 | 20.7 | 0.12 | B | B |
| | CK-2 | 1.48 | 31.2 | B | 1.38 | 21.1 | 0.11 | B | C |
| | CR-2 | 1.47 | — | B | 1.41 | — | 0.11 | B | C |
| | CG-2 | 1.46 | — | B | 1.39 | — | 0.10 | B | C |
| | CB-2 | 1.43 | — | B | 1.37 | — | 0.10 | B | C |
| Comparative | CC-3 | 1.47 | 31.5 | B | 1.41 | 23.8 | 0.10 | B | A |
| Example 3 | CM-3 | 1.48 | 32.8 | B | 1.43 | 24.1 | 0.09 | B | A |
| | CY-3 | 1.45 | 33.1 | B | 1.41 | 23.3 | 0.07 | B | A |
| | CK-3 | 1.49 | 31.7 | B | 1.44 | 24.1 | 0.09 | B | A |
| | CR-3 | 1.46 | — | B | 1.40 | — | 0.08 | B | A |
| | CG-3 | 1.47 | — | B | 1.38 | — | 0.09 | B | A |
| | CB-3 | 1.43 | — | B | 1.41 | — | 0.10 | B | A |

As is clear from Tables 2 and 3, the decrease in toner charge from before printing to after printing was small in the full-color toners obtained in the examples, and there was almost no change in dyeing density in a dyed cloth. It is therefore apparent that a dyed product can be provided having stable quality relative to the comparative examples.

In the printed intermediate recording media obtained in the examples, on which solid images were printed, it is apparent that uneven sweeping and image memory were reduced relative to the comparative examples, and that more uniform solid images were obtained.

It was confirmed that in the printed dyed products obtained in the examples, the colorimetry values of the non-image area portions were markedly lower than in the comparative examples. By visual observation as well, there was almost no staining of the non-image area, or staining was observed only to a slight degree, and it is apparent that staining of the non-image area of the dyed products was suppressed. It is also apparent that unevenness of dyeing was absent in the printed dyed products obtained in the examples, and that dyed products having high quality relative to the comparative examples were obtained.

### INDUSTRIAL APPLICABILITY

The sublimation transfer dyeing method of the present invention is capable of providing a high-quality dyed product having high dyeing density and no unevenness of dyeing, and has performance sufficient for practical use, and is therefore extremely useful as a sublimation transfer dyeing method using an electrophotographic process.

1. A sublimation transfer dyeing method, comprising:
attaching a toner to an intermediate recording medium by an electrophotographic process, and
sublimation-transferring a dye contained in the toner attached to the intermediate recording medium to an object to be dyed,
wherein the toner contains at least a polyester resin, a sublimable dye, and an external additive,
wherein the external additive contains at least strontium titanate, and
wherein the content of the strontium titanate with respect to the total mass of the toner is greater than 0.3 mass % and less than 3.0 mass %.

2. The sublimation transfer dyeing method according to claim 1, wherein the electrophotographic process is a dry development process.

3. The sublimation transfer dyeing method according to claim 1, wherein the object to be dyed is selected from the group consisting of a hydrophobic fiber or a structure thereof, a film or sheet comprised of a hydrophobic resin, and a fabric, glass, metal, and ceramics coated with a hydrophobic resin.

4. A dyed product dyed by the sublimation transfer dyeing method according to claim 1.

5. A toner used in the sublimation transfer dyeing method according to claim 1, comprising at least a polyester resin, a sublimable dye, and an external additive,
wherein the external additive contains at least strontium titanate, and
wherein the content of strontium titanate with respect to the total mass of the toner is greater than 0.3 mass % and less than 3.0 mass %.

6. An intermediate recording medium used in the sublimation transfer dyeing method according to claim 1,
wherein the toner is attached to the intermediate recording medium,
wherein the toner contains at least a polyester resin, a sublimable dye, and an external additive,
wherein the external additive contains at least strontium titanate, and
wherein the content of strontium titanate with respect to the total mass of the toner is greater than 0.3 mass % and less than 3.0 mass %.

7. A method for suppressing staining of a non-image area and unevenness of dyeing in a dyed product, using the sublimation transfer dyeing method according to claim 1.

8. A dyed product dyed by the sublimation transfer dyeing method according to claim 1, in which staining of a non-image area and unevenness of dyeing are suppressed.

9. A method for suppressing staining of a non-image area and unevenness of dyeing in a dyed product, using the toner according to claim 5.

10. A method for suppressing staining of a non-image area and unevenness of dyeing in a dyed product, using the intermediate recording medium according to claim 6.

11. An intermediate recording medium to which the toner according to claim 5 is attached.

12. The sublimation transfer dyeing method according to claim 2, wherein the object to be dyed is selected from the group consisting of a hydrophobic fiber or a structure thereof, a film or sheet comprised of a hydrophobic resin, and a fabric, glass, metal, and ceramics coated with a hydrophobic resin.

13. A dyed product dyed by the sublimation transfer dyeing method according to claim 2.

14. A toner used in the sublimation transfer dyeing method according to claim 2, comprising at least a polyester resin, a sublimable dye, and an external additive,
wherein the external additive contains at least strontium titanate, and
wherein the content of strontium titanate with respect to the total mass of the toner is greater than 0.3 mass % and less than 3.0 mass %.

15. An intermediate recording medium used in the sublimation transfer dyeing method according to claim 2,
wherein the toner is attached to the intermediate recording medium,
wherein the toner contains at least a polyester resin, a sublimable dye, and an external additive,
wherein the external additive contains at least strontium titanate, and
wherein the content of strontium titanate with respect to the total mass of the toner is greater than 0.3 mass % and less than 3.0 mass %.

16. A method for suppressing staining of a non-image area and unevenness of dyeing in a dyed product, using the sublimation transfer dyeing method according to claim 2.

17. A dyed product dyed by the sublimation transfer dyeing method according to claim 2, in which staining of a non-image area and unevenness of dyeing are suppressed.

18. A method for suppressing staining of a non-image area and unevenness of dyeing in a dyed product, using the toner according to claim 14.

19. A method for suppressing staining of a non-image area and unevenness of dyeing in a dyed product, using the intermediate recording medium according to claim 15.

20. An intermediate recording medium to which the toner according to claim 14 is attached.
